(19) United States
(12) Patent Application Publication
(10) Pub. No.: US 2007/0046618 A1
(43) Pub. Date: Mar. 1, 2007

(54) Display device and image forming apparatus with same

(75) Inventor: Keita Imai, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/508,702

(22) Filed: Aug. 23, 2006

(30) Foreign Application Priority Data
Aug. 29, 2005 (JP) 2005-247746

(51) Int. Cl. G09G 3/36

(52) U.S. Cl. 345/102

(57) ABSTRACT

In addition to a normal waiting mode of displaying in a whole screen of a liquid-crystal panel and a first power-saving mode of eliminating the displaying in a whole screen of the liquid-crystal panel, a second power-saving mode of displaying at a part of the liquid-crystal panel is provided. In the normal waiting mode, a controller controls the backlight to turn on a light illuminating a whole area and also controls a touch panel to be turned on. In the first power-saving mode, the controller turns off the light and also turns of the touch panel. In the second power saving mode, the controller controls the display section to display a summarized content of settings at the part of the liquid crystal panel, controls the backlight to turn on the light illuminating the part of the liquid crystal panel and turns off the touch panel.

### BACKGROUND OF THE INVENTION

1. Field of the Invention

The invention relates to a display device for displaying contents and the like of an operation instruction inputted by an operator and an image forming apparatus including the display device. More particularly, it relates to a power-saving technology for reducing electric power consumption.

2. Description of the Related Art

In a conventional display device for displaying contents and the like of an operation instruction inputted by an operator, when an operation is not performed for a predetermined time, suspension of displaying, e.g. turning off a backlight, is generally performed for a power-saving. For example, when the display device is not used for a predetermined time, the display device is switched to a power-saving mode and the backlight is turned off so as to suspend the display panel. When the display device is used again, the display device is reinstated from the power saving mode and turns on the backlight so as to make the display panel perform the displaying.

In the case of this technology, when the display device is in a normal waiting mode before being switched to the power-saving mode, information display sections of the display panel as well as portions on which information is not displayed are illuminated by the backlight. Accordingly, a great amount of electric power is consumed. Therefore, a technology described in a Japanese Unexamined Patent Publication No. 2003-279927 is proposed. In this technology, a backlight positioned at a character information display position is divided, and only the backlights located at the positions displaying character information are turned on.

A certain amount of an electric power can be reduced by the technology described in the Japanese Unexamined Patent Publication No. 2003-279927. However, there remains a possibility to achieve further power-saving of an electric power. For example, when a copying is performed, various kinds of information are displayed on the display panel. In some cases, when a copying is performed, information displayed on the display panel includes information which is irrelevant for performing the copying. According to the technology described in the Japanese Unexamined Patent Publication No. 2003-279927, all of the backlights located at character information portions are turned on. Accordingly, the backlights located at the portions displaying character information which is irrelevant for the copying operation are also turned on. Consequently, not enough power-saving can be achieved.

### SUMMARY OF THE INVENTION

The invention has worked out in view of the problems described above, and its object is to achieve more power-saving than the one performed by the conventional technology.

Namely, the display device according to the invention comprises: an operation instruction input section allowing an operator to input an operation instruction to make an operational mechanism perform a predetermined operation; a display section displaying on a display screen contents of the operation instruction inputted to the operation instruction input section by the operator; a display instruction input section allowing an operator to input a display instruction to make the display section display the operation instruction inputted to the operation instruction input section; and a controller controlling the display section to suspend the displaying of the contents of the operation instruction if no operation instruction is inputted to the operation instruction input section by the operator for a predetermined time, wherein the controller controls the display section to display a summarized content of the operation instruction which has been displayed on the display section at a part of the display screen of the display section when the display instruction input section receives the display instruction inputted to the display instruction input section by the operator.

According to this, when the display instruction for displaying the contents of an operation instruction inputted to the operation instruction input section by an operator in the case where the display device according to the invention is used in a copying machine and the like, the controller controls the display section to display a summarized content of the operation instruction which has been displayed by the display section at a part of the display screen of the display section. For example, the controller controls the display section to display information relevant for a copying e.g. size of a recording sheet, darkness, necessity of enlargement or contraction, necessity of double-side printing, number of copies and the like only in a corner of the display screen of the display section. Accordingly, contents of settings set by the operator can be visually confirmed by the operator through the summarized content. Further, the contents of the operation instruction are displayed only at a part of the display section so that further power-saving can be achieved.

In the technology described in the Japanese Unexamined Patent Publication No. 2003-279927, the displaying is performed in a full area of the character information display section. Accordingly, when the character information is displayed in a full area of the display panel, it would be necessary to perform the displaying in a full area of the display panel. Consequently, not enough power-saving can be achieved. According to the present invention, the summarized content is limitedly displayed only at a part of the display section. Accordingly, a further power-saving than the one made by the technology described in the Japanese Unexamined Patent Publication No. 2003-279927 can be achieved.

### BRIEF DESCRIPTION OF THE DRAWINGS

FIG. 1 is a front view of an input device which is a display device according to an embodiment of the invention.

FIG. 2 is a block diagram showing an electric construction of the input device.

FIG. 3 is a diagram for describing operation modes of the input device, the diagram showing state transitions among the operation modes.

FIG. 4 is a diagram for describing the operation modes of the input device, the diagram showing a state of operation of a liquid-crystal panel, a backlight and a touch panel in each of the operation mode.

FIG. 5 is a diagram showing an example of a summarized content displayed by divisionally driving a part of a displaying section.

### DETAILED DESCRIPTION OF THE PREFERRED EMBODIMENTS

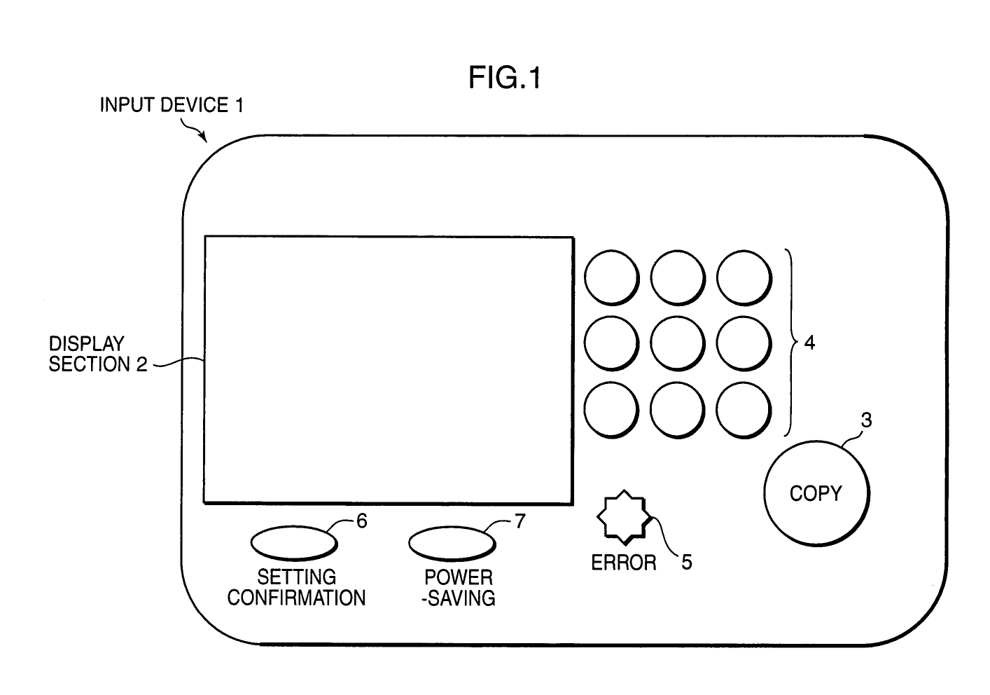

FIG. 1 is a front view of an input device 1 which is a display device according to an embodiment of the invention. The input device 1 is used, for example, as an input device mounted on an upper face of a copying machine. The input device 1 is provided with a display section 2, a copying button 3 and various kinds of keys 4 e.g. number keys and function keys. Further, the input device 1 is provided with an error lamp 5, a setting confirmation button 6 and a power-saving button 7 are provided.

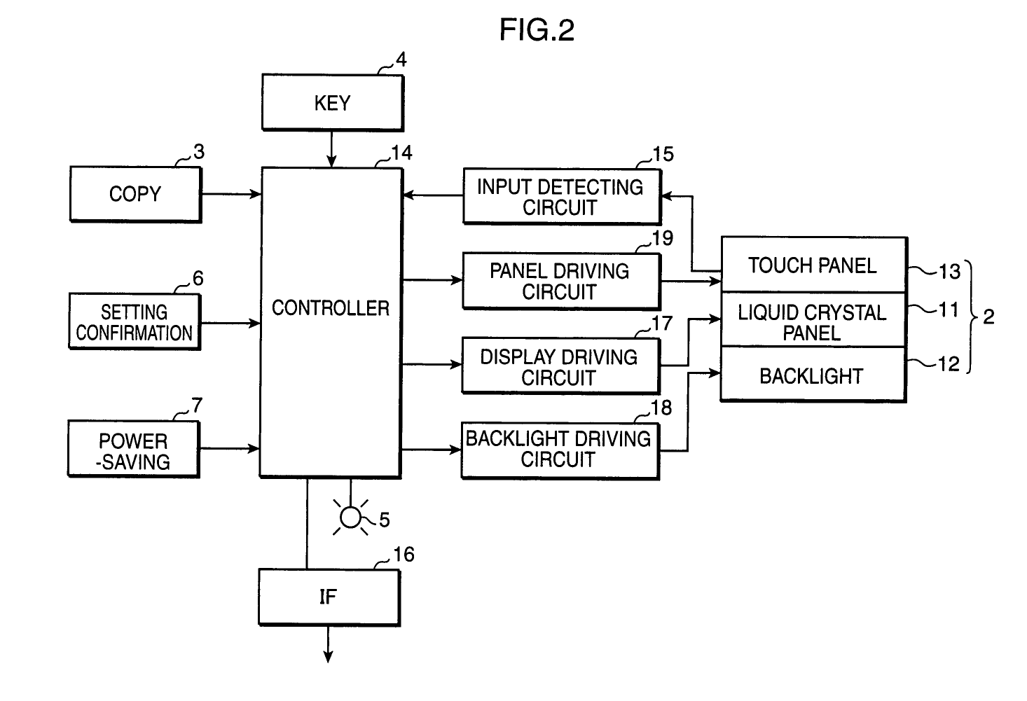

FIG. 2 is a block diagram showing an electric construction of the input device 1. The display section 2 includes a liquid crystal panel 11, a backlight 12 and a touch panel 13. The backlight 12 is provided on a back side of the liquid crystal panel 11. The touch panel 13 is provided on a front side of the liquid crystal panel 11. Contents of operations to the keys 4 and the buttons 3, 6, 7 are inputted to a controller 14. The controller 14 is realized by a microcomputer and the like. Contents of operations to the touch panel 13 are inputted to the controller 14 through an input detecting circuit 15. In accordance with the inputs, the controller 14 controls through an interface 16 an unillustrated image reading section and image forming section to perform a copying operation. Further, the controller 14 controls the liquid-crystal panel 11 to display contents of setting and a content of control through a display driving circuit 17.

The controller 14 controls the backlight 12 to turn on or off through a backlight driving circuit 18. Further, the controller 14 controls the touch panel 13 to turned on or off through a panel driving circuit 19.

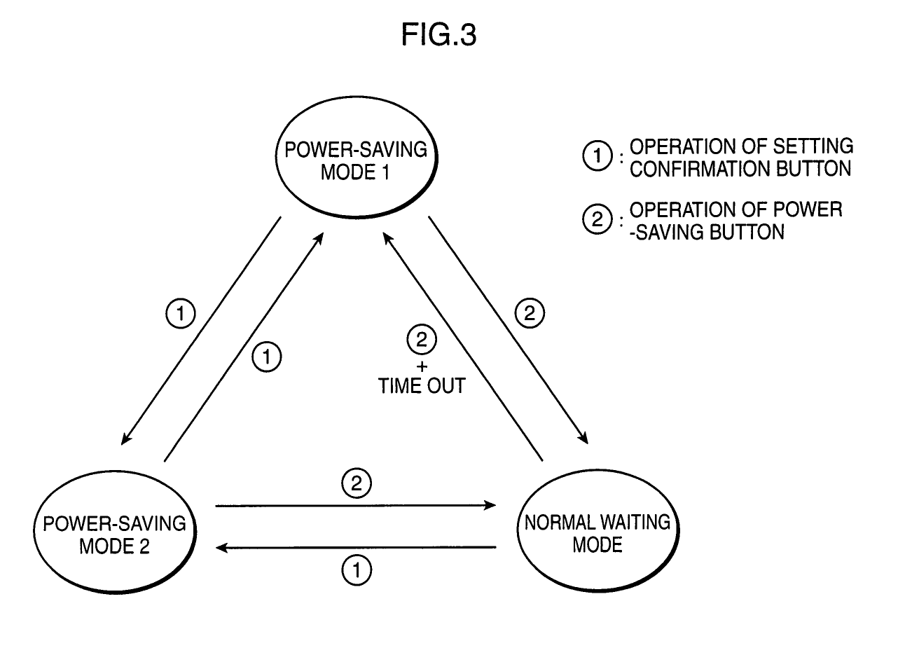

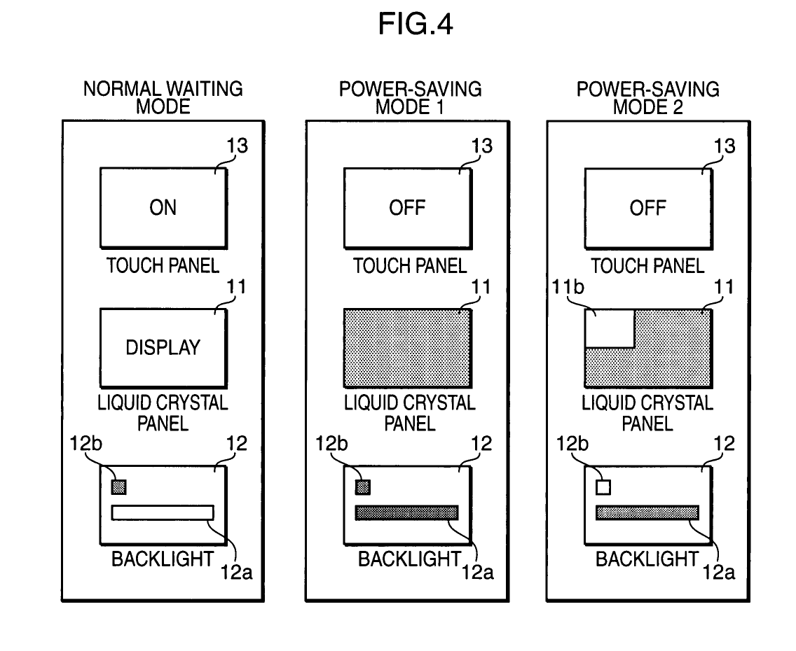

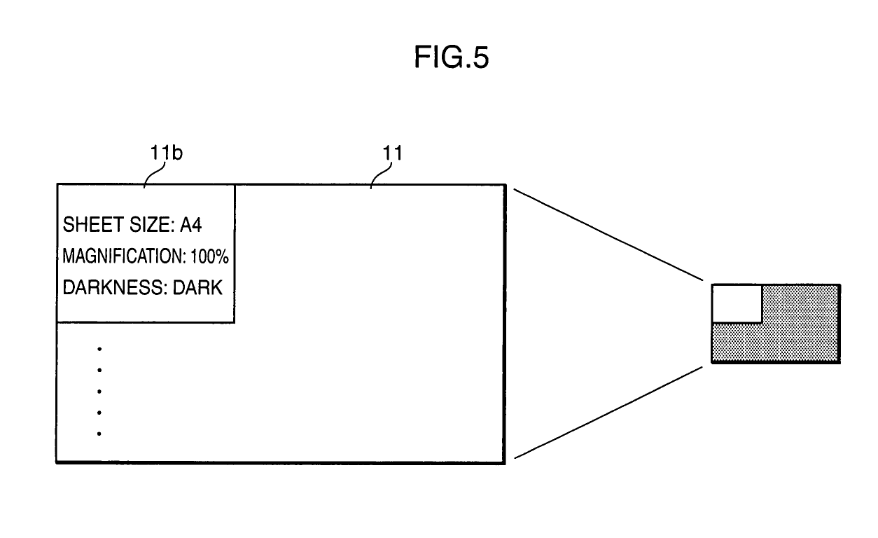

FIGS. 3 and 4 are diagrams for describing operation modes of the input device 1 which is constructed as described above. FIG. 3 is a diagram showing state transitions among the operation modes. FIG. 4 is a diagram showing a state of operation of the liquid-crystal panel 11, the backlight 12 and the touch panel 13 in each of the operation modes. Further, FIG. 5 is a diagram showing an example of a summarized content displayed by divisionally driving parts of the display section.

In the input device 1, the liquid crystal panel 11 is operable to drive divisionally so that the displaying can be performed divisionally as shown in FIG. 5. Correspondingly, the backlight 12 includes a light 12a for illuminating a full area of the liquid crystal panel 11 and a light 12b for partially illuminating the liquid crystal panel 11. A backlight driving circuit 18 selectively drives the lights 12a, 12b.

In the input operation device 1 of the invention, as shown in FIG. 4, in addition to a normal waiting mode of performing the displaying in a full area of the liquid-crystal panel 11 and a first power-saving mode of suspending the displaying, a second power-saving mode of performing the displaying at a part 11b of the liquid-crystal panel 11 is provided. In the first and second power-saving modes, the controller 14 does not receive an input of operation to the touch panel 13 but receives operation of the keys 4 and buttons 3, 6, 7 which are other than the operation of the touch panel 13 at any time. The controller 14 performs controls of the liquid-crystal display panel 11, the touch panel 13 and the backlight driving circuit 18 in the respective modes and controls of the operation instruction inputted through the keys 4 and buttons 3, 6, 7 by an operator.

Further, in the normal waiting mode, the controller 14 controls the liquid crystal panel 11 to display in a full area on the display screen and controls the backlight 12 to turn on the light 12a which illuminates a full area of the liquid crystal panel 11. In the normal waiting mode, the controller 14 controls the touch panel 13 to be in a state of “ON” where the touch panel 13 is capable of receiving the operation instruction inputted by the operator.

Further, the first power-saving mode is a general power-saving mode. In the first power-saving mode, the controller 14 controls the liquid crystal panel 11 to suspend the displaying in a full area and controls the backlights 12a, 12b of the backlight 12 to turn off. Further, the touch panel 13 is controlled to be in a state of “OFF” where the touch panel 13 does not receive an operation instruction inputted by the operator. In the second power-saving mode, the controller 14 controls the liquid-crystal panel 11 to display only at the part 11b, controls the light 12b of the backlight 12 to illuminate the part 11b of the liquid crystal panel 11 and controls the touch panel 13 to be in a state of “OFF” where the touch panel 13 does not receive an operation instruction inputted by the operator.

Hereinafter, descriptions are made with reference to FIG. 3. If no operation is inputted for a predetermined time (for example, 10 minutes) during when the input device 1 is in the normal waiting mode, the controller 14 which is a control section switches the input device 1 to the first power-saving mode. In the first power-saving mode, the controller 14 controls the liquid crystal panel 11 to suspend the displaying and turns off the lights 12a, 12b of the backlight 12. The controller 14 controls the touch panel 13 to be in the state of “OFF.” Further, also if the operator operates the power-saving button 7 to input an instruction to switch the input device 1 to the first power-saving mode during when the input device 1 is in the normal waiting mode, the controller 14 switches the input operation device 1 to the first power-saving mode.

In the first power-saving mode, the controller 14 does not switch the input device 1 into the normal waiting mode but maintains the first power-saving mode even if an unillustrated document detecting sensor detects that a document is set on a tray or if an unillustrated document cover open/close detecting switch detects that a document cover is opened. In the state of being in the first power-saving mode, the controller 14 receives an operation instruction inputted by an operator through operation of the copying button 3 which is an image forming instructing section and controls the image forming section to perform a copying operation while maintaining the state of suspending the displaying of the liquid crystal panel 11. Accordingly, for example, when the copying is performed with default values (one copy of a document is printed with an automatically set size of a recording sheet and darkness in the same size from one side to one side), namely, when a notification of contents of settings is not so needed to be reported to the operator, the controller 14 does not control the liquid crystal panel 11 to perform the displaying. Since the display section 2 does not perform the displaying of irrelevant information, a consumption of an electric power is considerably reduced.

In the conventional technology, a copying operation is not performed in the state of suspending the displaying of the liquid crystal panel 11 (in the power-saving mode) as described above. If the document is set or the document cover is opened, the controller 14 controls the input operation device 1 to be reinstated to the normal waiting mode and controls the liquid crystal panel 11 to display the contents of the settings. Then, the controller 14 makes the copying operation be performed.

When the operator operates the power-saving button 7 to input an instruction to reinstate the input device 1 to the normal waiting mode, the controller 14 switches the input device 1 from the first power-saving mode to the normal waiting mode.

Further, if the operator operates the setting confirmation button (an example of an operation instruction input section) 6 to input an instruction to display contents of the settings when the input device 1 is in the first power-saving mode, the controller 14 switches the input device 1 to the second power-saving mode. In the second power-saving mode, the controller 14, as shown in FIG. 5, controls the liquid crystal panel 11 to display contents of the current settings (minimal information) set by the operator on the part 11b as a summarized contents, controls the backlight 12 to turn off the light 12a but turn on the light 12b having a lower ability to illuminate.

The controller 14 controls the liquid crystal panel 11 to display the summarized contents of settings on the part 11b in the following manners. (1) The controller 14 extracts a part of the current information of contents of the operation instruction set by the user and having been displayed on the display section 2 and edits the same into such a size as to fall within the part 11b. In this case, it is preferable that sizes of displayed characters are the same as that having been displayed on the liquid crystal panel 11 in the normal waiting mode. However, the texts may be contracted. In this case, information displayed in the normal waiting mode is a setting input screen including various kinds of options while information displayed in the second power-saving mode is a screen displaying a summary of the result of selection. Therefore, in the second power-saving mode, even though the display area is small, relevant information can be visually confirmed by the operator. (2) The controller 14 contracts the display screen of the contents of operation instruction having been displayed on the display section 2 in the normal waiting mode into such a size as to fall within the part 11b.

In the second power-saving mode, the controller 14 receives the operation instruction inputted by the operator through operation of the copying button 3 which is an image forming instructing section and controls so as to enable the copying operation to be operated while maintaining the displaying of summarized contents by the liquid crystal panel 11. The controller 14 controls the touch panel 13 to be in a state of “OFF” and does not receive instruction from the touch panel 13.

In the first power-saving mode, the operator can confirm nothing. However, on the contrary to the case of the first power-saving mode, the operator can confirm information displayed in a summarized screen in the second power-saving mode. Further, as compared to the case where the light 12a for illuminating full area of the liquid crystal panel 11 as in the normal waiting mode, consumption of electric power is reduced. Furthermore, in the second power-saving mode, the controller 14 controls the display section 2 to just display the summarized screen and turns the touch panel 13 to be in the state of “OFF.” Accordingly, consumption of an electric power in the touch panel 13 can be also reduced.

In the second power-saving mode, if the operator operates the setting confirming button 6 to input an instruction to suspend the displaying of contents of the settings, the controller 14 switches the state of input device 1 to the first power-saving mode.

Furthermore, in the second power-saving mode, if the operator operates the power-saving button 7 to input an instruction to reinstate the input device to the normal waiting mode, the controller 14 switches the state of the input device 1 to the normal waiting mode. In the normal waiting mode, the controller 14 controls the display section 2 to change the displaying of a part of the information in the summarized screen in the second power-saving mode to the setting screen displaying in detail the contents of the settings set by the operator and the contents set in default.

Further, in the normal waiting mode, if the operator operates the setting confirming button 6 to input an instruction to display the summarized screen, the controller 14 switches the state of the input operation device 1 to the second power-saving mode and controls the display section 2 to display the summarized screen.

By performing the control as described above, the copying operation is performed while suspending the displaying by the display section 2 even in the state of being in the first power saving mode where all of the displaying in the display section 2 is suspended. Accordingly, further power saving is achieved.

When the operator needs to confirm the settings, the controller controls the backlight 12a which is irrelevant in the displaying of the summarized screen and the touch panel 13 to be turned off while maintaining the displaying of information necessary for the displaying of the summarized screen. Accordingly, even when the operator needs to confirm the settings, further power-saving than the one made in the conventional manner can be achieved.

Further, in the first power-saving mode, if a shortage of the recording sheet having a desired size occurs when a document is set or an error (defect) such as a paper jamming on the way of copying occurs, the controller 14 controls the error lamp 5 which is a defect reporting section to be turned on or blinked. Accordingly, the operator can realize occurrence of defect without depending upon the displaying on the screen of the display section 2. After confirming the lighting or blinking of the error lamp 5, the operator can confirm detailed information concerning the defect by operating the power-saving button 7. Alternatively, the operator can confirm the summarized screen by operating the setting confirmation button 6. As the defect reporting section for reporting the error, it is not limited to reporting by light of the error lamp 5 but reporting by sound of the buzzer may be used.

In the above-described embodiment, the case where the input device 1 according to the embodiment of the invention is used in a copying machine is described. However, the input device 1 according to the embodiment of the invention can be preferably applied to a general electronic device having a power-saving mode. Since there is a limit in an electric power accumulated in the battery and there is a necessity to utilize an electric power stored in the battery more efficiently especially in the case where the input operation device 1 is applied to an electronic device (a laptop PC, a mobile device and the like) having an electric power source of an electricity charging device such as a battery and the input operation device 1 is driven by an electric power fed by the battery, it is so effective to achieve the power-saving control as described above.

In short, the display device according to the invention comprises: an operation instruction input section allowing an operator to input an operation instruction to make an operational mechanism perform a predetermined operation; a display section displaying on a display screen contents of the operation instruction inputted to the operation instruction input section by the operator; a display instruction input section allowing an operator to input a display instruction to make the display section display the operation instruction inputted to the operation instruction input section; and a controller controlling the display section to suspend the displaying of the contents of the operation instruction if no operation instruction is inputted to the operation instruction input section by the operator for a predetermined time, wherein the controller controls the display section to display a summarized content of the operation instruction which has been displayed on the display section at a part of the display screen of the display section when the display instruction input section receives the display instruction inputted to the display instruction input section by the operator.

Further, in the display device according to the invention, the controller controls the display section to display the summarized content of the operation instruction only at the part of the display screen of the display section when the display instruction input section receives a display instruction during when the displaying of the contents of an operation instruction by the display section is suspended.

According to the inventions, if the operator inputs the display instruction of displaying the contents of the operation instruction inputted to the operation instruction inputting section by the operator when the display device according to the invention is used in the copying machine and the like for allowing the operator to input an operation instruction, the controller controls the display section to display a summarized content of the operation instruction at a part of the display screen of the display section. For example, the controller controls the display section to display information necessary for a copying operation such as a size of a recording sheet, darkness, necessity of enlargement or contraction, necessity of double-side printing, number of copies and the like only at a corner of the display screen of the display section. Accordingly, contents set by the operator are visually confirmed by the operator through the summarized content. Further, the contents of the operation instruction are displayed only at a part of the screen so that further power-saving can be achieved.

In the technology described in the Japanese Unexamined Patent Publication No. 2003-279927, the displaying of the character information displaying portion is performed in a full area. Accordingly, the displaying is needed to be performed throughout a whole area of the display panel when the displaying of the character information is performed. Accordingly, not enough power-saving can be achieved. In the invention, the displaying of the summarized content is performed limitedly only at a part of the display section. Accordingly, a further power-saving than the one made by the technology described in the Japanese Unexamined Patent Publication No. 2003-279927 can be achieved.

Further, in the present invention, wherein the summarized content of the operation instruction is an extraction of the contents of the operation instruction which has been displayed on the display section, and is edited into such a size as to fall within the part of the display screen of the display section.

According to the invention, the controller controls the display section to display the summarized content of the operation instruction which is formed by extracting a part of the contents of the operation instruction and editing the same. Accordingly, amount of information displayed as the summarized content is reduced so that an area for allocating information subjected to be displayed can be made wider and the information to be displayed can be made large. Consequently, it becomes easy for the operator to grasp the contents of settings, and the power-saving can be achieved.

Further, in the present invention, the summarized content of the operation instruction is a contraction of the contents of the operation instruction which has been displayed on the display section into such a size as to fall within the part of the display screen of the display section.

According to the invention, the controller controls the display section to display the summarized content of the operation instruction made by contraction the contents of the operation instruction. Accordingly, without reducing amount of information to be displayed, the operator can grasp the contents of settings and the power-saving can be achieved.

Further, in the present invention, the display section includes a display panel and a backlight illuminating the display panel, the controller has a full area illumination control mode of illuminating a full area of the display panel and a partial area illumination control mode of partially illuminating the display panel, the controller switches the backlight to the partial area illumination control mode in the case of displaying the summarized content of the operation instruction at the part of the display screen, and the controller switches the backlight to the full area illumination control mode in the case of displaying contents of the operation instruction on the full area of the display screen.

According to the invention, not only the displaying on the liquid crystal panel but also the area of illumination of the backlight is switched in accordance with the displaying on the screen. Accordingly, further power-saving can be achieved.

Further, in the present invention, the display section further includes a touch panel over the display panel receiving an operation instruction inputted by the operator, the controller controls the touch panel to suspend the receiving of an operation instruction when executing the partial area illumination control mode and controls the touch panel to perform the receiving of an operation instruction when executing the full area illumination control mode.

According to the invention, in a summarized screen mode, the touch panel is suspended while a function for allowing the operator to confirm the contents of settings is maintained. Consequently, further power saving can be achieved.

Further, in the present invention, a defect reporting section for reporting occurrence of a defect is provided separately from the display section, the controller controls the defect reporting section to report occurrence of a defect when a defect occurs during when the summarized contents of the operation instruction is displayed on the display section.

According to the invention, occurrence of the defect is identified by the operator without depending upon the displaying of the display section.

Further, in the present invention, an electric power charging device is provided as an electric power source, the display device is driven by an electric power supplied by the electric power charging device.

In the case of the display device having an electricity charging device as an electric power source, there is a limit in an electric power accumulated in the battery and there is a necessity to efficiently utilize an electric power stored in the battery. According to the invention, it is very effective to achieve the power-saving control as described above.

Further, in the invention, the controller allows only the operation instruction input section to receive the operation instruction inputted by the operator while maintaining the state of suspending the displaying by the display section when no operation instruction is inputted to the operation instruction input section by the operator for a predetermined time and the displaying of the contents of the operation instruction by the display section is suspended.

According to the invention, the controller suspends the display section while maintaining a function to receive an operation instruction inputted by the operator through the operation instruction inputting section. Accordingly, since the state of suspending the displaying is maintained, consumption of electric power can be reduced further than in the conventional manner.

Further, in the invention, A display device including an operation instruction input section allowing an operator to input an operation instruction to make an operational mechanism to perform a predetermined operation comprising: a display section displaying on a display screen contents of an operation instruction inputted to the operation instruction input section by the operator; and a controller controlling the display section to suspend the displaying of the contents of the operation instruction when no operation instruction is inputted to the operation instruction input section by the operator for a predetermined time, wherein the controller controls the operation instruction input section to receive an operation instruction inputted by the operator while maintaining the state of suspending the displaying of the display section when the display section is controlled to suspend displaying contents of the operation instruction on the display section.

According to the invention, the controller suspends the display section while maintaining a function to receive an operation instruction inputted by the operator through the operation instruction inputting section. Accordingly, since the state of suspending the displaying is maintained, consumption of electric power can be reduced further than in the conventional manner.

Further, the invention is an image forming apparatus comprising the display device according to the invention described above.

Further, in the invention, the operational mechanism is an image forming mechanism; the operation instruction is an instruction to make the image forming mechanism perform an image forming operation; and the controller controls the operation instruction input section to receive operation instruction inputted to the operation instruction input section by the operator while maintaining the state of suspending the displaying of the display section when the display section is controlled to suspend the displaying of contents of the operation instruction.

According to the invention, the controller suspends the display section while maintaining a function to receive an operation instruction inputted by the operator through the operation instruction inputting section. Accordingly, since the state of suspending the displaying is maintained, consumption of electric power can be reduced further than in the conventional manner.

This application is based on patent application No. 2005-247746 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A display device comprising:
an operation instruction input section allowing an operator to input an operation instruction to make an operational mechanism perform a predetermined operation;
a display section displaying on a display screen contents of the operation instruction inputted to the operation instruction input section by the operator;
a display instruction input section allowing an operator to input a display instruction to make the display section display the operation instruction inputted to the operation instruction input section; and
a controller controlling the display section to suspend the displaying of the contents of the operation instruction if no operation instruction is inputted to the operation instruction input section by the operator for a predetermined time, wherein
the controller controls the display section to display a summarized content of the operation instruction which has been displayed on the display section at a part of the display screen of the display section when the display instruction input section receives the display instruction inputted to the display instruction input section by the operator.

2. A display device according to claim 1, wherein the controller controls the display section to display the summarized content of the operation instruction only at the part of the display screen of the display section when the display instruction input section receives a display instruction during the time when the displaying of the contents of an operation instruction by the display section is suspended.

3. A display device according to claim 1, wherein the summarized content of the operation instruction is an extraction of the contents of the operation instruction which has been displayed on the display section, and is edited into such a size as to fall within the part of the display screen of the display section.

4. A display device according to claim 1, wherein the summarized content of the operation instruction is a contraction of the contents of the operation instruction which has been displayed on the display section into such a size as to fall within the part of the display screen of the display section.

5. A display device according to claim 1, wherein:
the display section includes a display panel and a backlight illuminating the display panel,
the controller has a full area illumination control mode of illuminating a full area of the display panel and a partial area illumination control mode of partially illuminating the display panel,
the controller switches the backlight to the partial area illumination control mode in the case of displaying the summarized content of the operation instruction at the part of the display screen, and the controller switches the backlight to the full area illumination control mode in the case of displaying contents of the operation instruction on the full area of the display screen.

6. A display device according to claim 5, wherein the display section further includes a touch panel over the display panel receiving an operation instruction inputted by the operator, the controller controls the touch panel to suspend the receiving of an operation instruction when executing the partial area illumination control mode and controls the touch panel to perform the receiving of an operation instruction when executing the full area illumination control mode.

7. A display device according to claim 1, wherein a defect reporting section reporting occurrence of a defect is provided separately from the display section, the controller controls the defect reporting section to report occurrence of a defect when a defect occur during when the summarized contents of the operation instruction is displayed on the display section.

8. A display device according to claim 1, wherein an electric power charging device is provided as an electric power source, the display device is driven by an electric power supplied by the electric power charging device.

9. A display device according to claim 1, wherein the controller allows only the operation instruction input section to receive the operation instruction inputted by the operator while maintaining the state of suspending the displaying by the display section when no operation instruction is inputted to the operation instruction input section by the operator for a predetermined time and the displaying of the contents of the operation instruction by the display section is suspended.

10. A display device including an operation instruction input section allowing an operator to input an operation instruction to make an operational mechanism to perform a predetermined operation comprising:
a display section displaying on a display screen contents of an operation instruction inputted to the operation instruction input section by the operator; and
a controller controlling the display section to suspend the displaying of the contents of the operation instruction when no operation instruction is inputted to the operation instruction input section by the operator for a predetermined time, wherein
the controller controls the operation instruction input section to receive an operation instruction inputted by the operator while maintaining the state of suspending the displaying of the display section when the display section is controlled to suspend displaying contents of the operation instruction on the display section.

11. An image forming apparatus comprising the display device according to claim 1.

12. An image forming apparatus according to claim 11, wherein:
the operational mechanism is an image forming mechanism;
the operation instruction is an instruction to make the image forming mechanism perform an image forming operation; and
the controller controls the operation instruction input section to receive operation instruction inputted to the operation instruction input section by the operator while maintaining the state of suspending the displaying of the display section when the display section is controlled to suspend the displaying of contents of the operation instruction.

13. An image forming apparatus comprising the display device according to claim 10.
